(19) United States
(12) Patent Application Publication
(10) Pub. No.: US 2007/0204327 A1
(43) Pub. Date: Aug. 30, 2007

(54) Method, apparatus, and computer product for protecting terminal security

(75) Inventors: Tohru Nishioka, Kawasaki (JP); Akira Nakanishi, Kawasaki (JP); Kenshi Takamoto, Kawasaki (JP); Yoshiyuki Iijima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/790,901

(22) Filed: Apr. 27, 2007

Related U.S. Application Data
(63) Continuation of application No. PCT/JP04/16144, filed on Oct. 29, 2004.

(51) Int. Cl. H04L 9/00

(52) U.S. Cl. 726/1

(57) ABSTRACT

A determining unit determines whether a terminal is in a communicable state with other terminal via a personal area network. A restricting unit restricts use of the terminal, when the determining unit determines that the terminal is not in the communicable state with the other terminal via the personal area network.

### BACKGROUND OF THE INVENTION

1. Field of the Invention

The present invention relates to a technology for protecting a terminal from illegal use.

2. Description of the Related Art

Conventionally, for a terminal having a possibility of loss or theft such as a mobile phone or a notebook personal computer, illegal use of the terminal has been prevented by a method of inputting a password at the time of startup (see, for example, Japanese Patent Application Laid-open No. H6-35858).

However, in the method of inputting the password at the time of startup, the password needs to be input every time the power is turned on. Therefore, many users do not use a security lock mechanism, and consequently security protection of the terminal is not sufficient.

### SUMMARY OF THE INVENTION

It is an object of the present invention to at least partially solve the problems in the conventional technology.

An apparatus for protecting an illegal use of a terminal, according to one aspect of the present invention, includes a determining unit that determines whether the terminal is in a communicable state with other terminal via a personal area network; and a restricting unit that restricts use of the terminal, when the determining unit determines that the terminal is not in the communicable state.

A method of protecting an illegal use of a terminal, according to another aspect of the present invention, includes determining whether the terminal is in a communicable state with other terminal via a personal area network; and restricting use of the terminal, when it is determined that the terminal is not in the communicable state.

A computer-readable recording medium according to still another aspect of the present invention stores therein a computer program for protecting an illegal use of a terminal. The computer program causes a computer to execute determining whether the terminal is in a communicable state with other terminal via a personal area network; and restricting use of the terminal, when it is determined that the terminal is not in the communicable state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a concept of security protection of a terminal according to an embodiment of the present invention;

FIG. 2 is a functional block diagram of a configuration of a terminal-security protecting unit that protects security of the terminal according to the embodiment;

FIG. 3 is a schematic diagram of an example of data structure in a security-information storing unit;

FIG. 4 is a schematic diagram for explaining a communication confirmation between terminals via a PAN according to the embodiment;

FIG. 5 is a flowchart of a communication-confirming process performed by a communication confirming unit with other terminals;

FIG. 6 is a flowchart of a response process performed by a communication-confirmation responding unit;

FIG. 7 is a flowchart of a setting process performed by a setting processor; and

FIG. 8 is a schematic diagram for explaining a hardware configuration of a terminal that executes a terminal-security protecting program according to the embodiment.

### DETAILED DESCRIPTION OF THE PREFERRED EMBODIMENTS

Exemplary embodiments of the present invention are explained in detail below with reference to the accompanying drawings. Note that the invention is not limited to the embodiments.

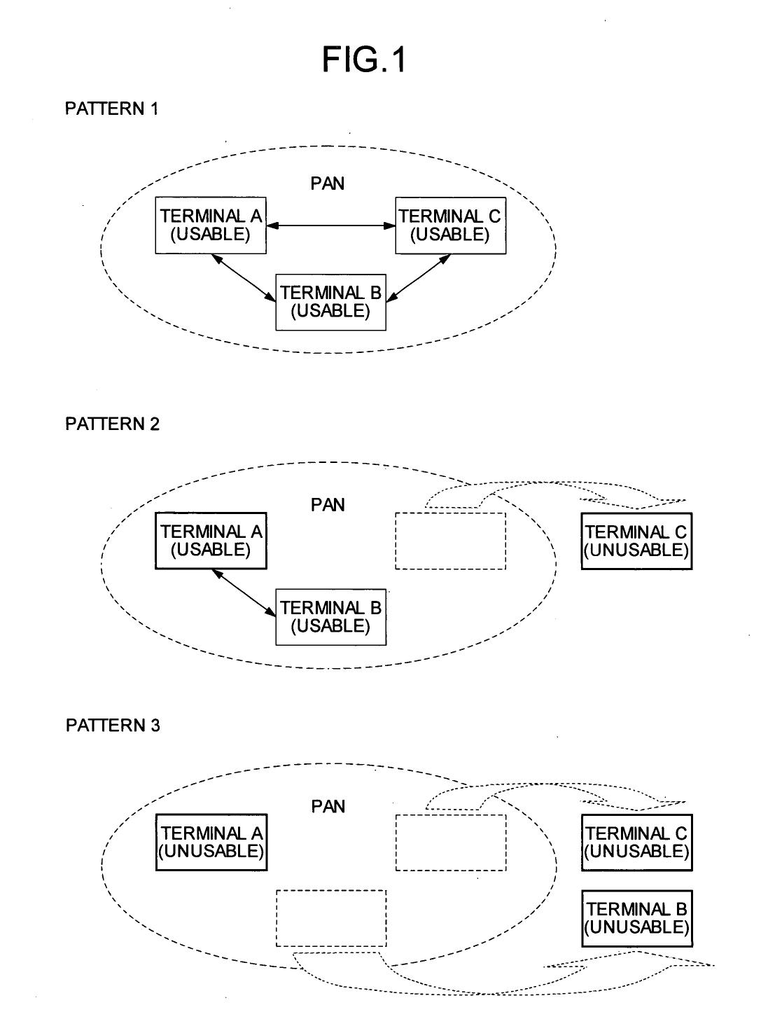

FIG. 1 is a schematic diagram for explaining a concept of security protection of a terminal according to an embodiment of the present invention. The terminal shown in FIG. 1 is any one of a mobile phone, a portable information terminal, a personal computer, a wristwatch terminal, a digital versatile disk (DVD) player, a digital television, and the like.

As shown in a pattern 1 in FIG. 1, the terminal builds a personal area network (PAN) between terminals. A PAN interface is any one of a wireless local area network (LAN), Bluetooth, ultra wideband (UWB), and the like.

The pattern 1 indicates a case that three terminals A, B, and C constitute the PAN. The respective terminals use the PAN to confirm communication regularly relative to other terminals, and if communication is confirmed, a usable state can be maintained.

On the other hand, as shown in a pattern 2, when the terminal C cannot communicate with other terminals for a certain period via the PAN, the terminal C cannot be used. Alternatively, functions available to the terminal C are limited.

Thus, the terminal according to the present embodiment can be used when communication with other terminals via the PAN is possible, and when communication with other terminals via the PAN is not possible due to a theft or the like, the terminal cannot be used or the use of the terminal is restricted. Therefore, when there is a possibility that one terminal can be illegally used due to a theft, the terminal cannot be used automatically, or the use of the terminal is restricted, thereby enabling protection of the security of the terminal.

In addition, as shown in a pattern 3, when the terminals B and C cannot communicate with the terminal A via the PAN, terminals B and C become unusable, and the terminal A cannot be used either because there is no terminal communicable with the terminal A via the PAN.

Even when terminals B and C cannot communicate with the terminal A via the PAN, terminals B and C can be used when the terminal B can communicate with the terminal C via the PAN.

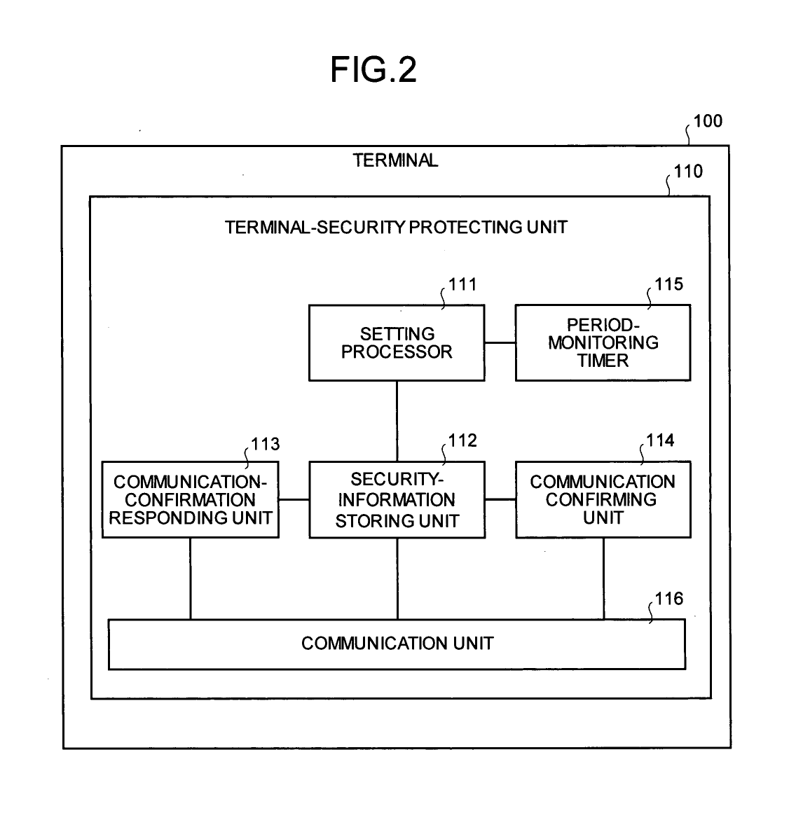

FIG. 2 is a functional block diagram of a configuration of a terminal-security protecting unit 110 that protects the security of a terminal 100 according to the present embodiment.

The terminal-security protecting unit 110 of the terminal 100 includes a setting processor 111, a security-information storing unit 112, a communication-confirmation responding unit 113, a communication confirming unit 114, a period-monitoring timer 115, and a communication unit 116.

The setting processor 111 make a setting for registering the terminal 100 in the PAN, and sets a function, use of which is restricted when there is a possibility that the terminal 100 is illegally used, as a security lock function. The setting processor 111 receives a setting instruction from a user and stores the instruction in the security-information storing unit 112.

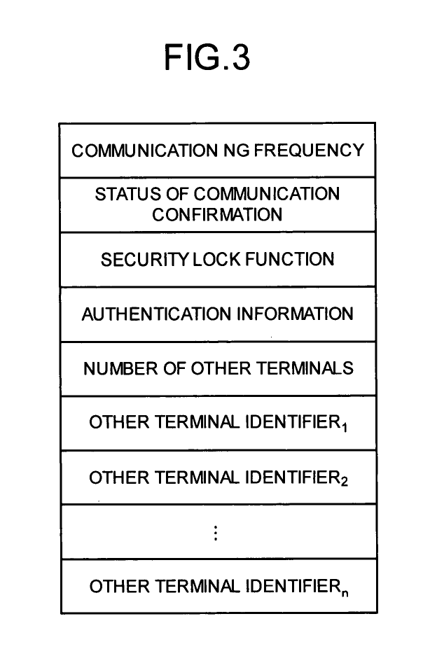

The security-information storing unit 112 stores information used for protecting the security of the terminal. FIG. 3 is a schematic diagram of an example of data structure in the security-information storing unit 112.

As shown in FIG. 3, the security-information storing unit 112 includes communication NG frequency, status of communication confirmation, the security lock function, authentication information, number of other terminals, and other terminal identifiers 1 to n.

The communication NG frequency is number of times when a response to the communication confirmation relative to other terminals by the communication confirming unit 114 cannot be obtained from any terminal. If the communication NG frequency has reached or exceeded the predetermined number of retries, the communication confirming unit 114 determines that the terminal 100 is being illegally used.

The status of communication confirmation is a flag indicating whether communication confirmation is received from other terminals. When there is a communication confirmation from other terminals, the flag is set to “1” by the communication confirmation responding unit 113, and when the communication confirming unit 114 confirms communication, the flag is set to “0”.

The security lock function is a function, use of which is restricted when there is a possibility that the terminal is illegally used, and is set by the setting processor 111. As the security lock function, for example, when the terminal is a mobile phone, the user can specify a function for suspending functions other than a function for releasing the security lock such as inputting a password (power is kept on, corresponds to dial lock), or a function for changing a setting so as to require input of the password after the power is turned on and automatically turning off the power.

The authentication information is a password input by the user when the security lock is to be released. The number of other terminals is the number n of other terminals constituting the PAN, and it is set by the setting processor 111 when the terminal 100 is registered in the PAN.

These other terminal identifiers 1 to n are terminal identification information used when the user communicates with other terminals registered in the PAN, and, for example, when the PAN is the wireless LAN, the identifiers are IP addresses. These other terminal identifiers 1 to n are set by the setting processor 111 when the terminal 100 is registered in the PAN.

The communication-confirmation responding unit 113 receives communication confirmation from other terminals via the PAN, responds to the confirmation, and upon reception of the communication confirmation, sets the status of communication confirmation to “1”.

The communication confirming unit 114 regularly performs communication confirmation by using the PAN relative to other terminals. For example, when the PAN is the wireless LAN, the communication confirming unit 114 can perform the communication confirmation by using PING.

The communication confirming unit 114 stores the number of times when there is no response to the communication confirmation from any terminal as the communication NG frequency in the security-information storing unit 112, and when the communication NG frequency has reached or exceeded the predetermined number of retries, activates the security lock function stored in the security-information storing unit 112.

The communication confirming unit 114 regularly performs communication confirmation by using the PAN relative to other terminals and activates the security lock function when the communication NG frequency has reached or exceeded the predetermined number of retries. Accordingly, it can be prevented that the terminal 100 is illegally used due to a theft or the like.

The period-monitoring timer 115 counts a predetermined period of time. The communication confirming unit 114 uses the period-monitoring timer 115 to perform communication confirmation regularly relative to other terminals via the PAN.

When the status of communication confirmation in the security-information storing unit 112 is set to “1”, that is, when the communication-confirmation responding unit 113 responds to the communication confirmation from other terminals, the communication confirming unit 114 resets the period-monitoring timer 115 to restart the timer, and sets the communication NG frequency and the status of communication confirmation to “0”.

The communication unit 116 communicates with other terminals via the PAN. For example, the communication unit 116 transmits communication confirmation to other terminals according to an instruction from the communication confirming unit 114 and receives a response to the communication confirmation from other terminals.

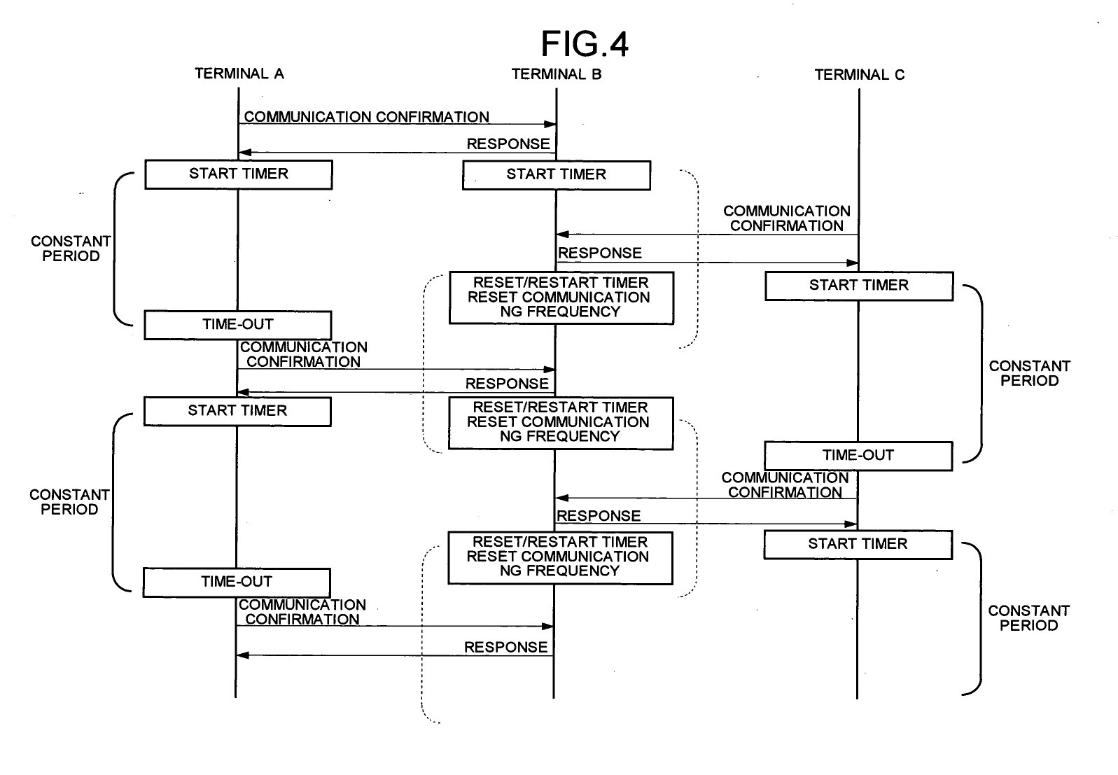

FIG. 4 is a schematic diagram for explaining communication confirmation between terminals via the PAN according to the present embodiment, in which the terminals A, B, and C constitute the PAN to perform the communication confirmation.

As shown in FIG. 4, the terminal A performs communication confirmation relative to the terminal B via the PAN, and when there is a response from the terminal B, the terminal A starts the period-monitoring timer. When the period-monitoring timer times out, the terminal A performs communication confirmation relative to the terminal B, and when there is a response from the terminal B, the terminal A restarts the period-monitoring timer.

When the terminal B responds to the communication confirmation from the terminal A, the terminal B starts the period-monitoring timer. When the terminal B responds to the communication confirmation from the terminal C, the terminal B resets the period-monitoring timer to restart the timer, and resets the communication NG frequency.

When the terminal B responds to the communication confirmation from the terminal A, the terminal B resets the period-monitoring timer to restart the timer, and resets the communication NG frequency. When the terminal B responds to the communication confirmation from the terminal A, the terminal B resets the period-monitoring timer to restart the timer, and resets the communication NG frequency.

The terminal C performs communication confirmation relative to the terminal B via the PAN, and when there is a response from the terminal B, the terminal C starts the period-monitoring timer. When the period-monitoring timer times out, the terminal C performs communication confirmation relative to the terminal B, and when there is a response from the terminal B, the terminal C restarts the period-monitoring timer.

In this manner, each of the terminals repeats communication confirmation at a constant period by using the period-monitoring timer, and when the terminal responds to the communication confirmation from other terminals, resets the timer to restart the timer, thereby to repeat an operation of resetting the communication NG frequency. Accordingly, it can be determined whether a terminal comes off from the PAN due to a theft or the like.

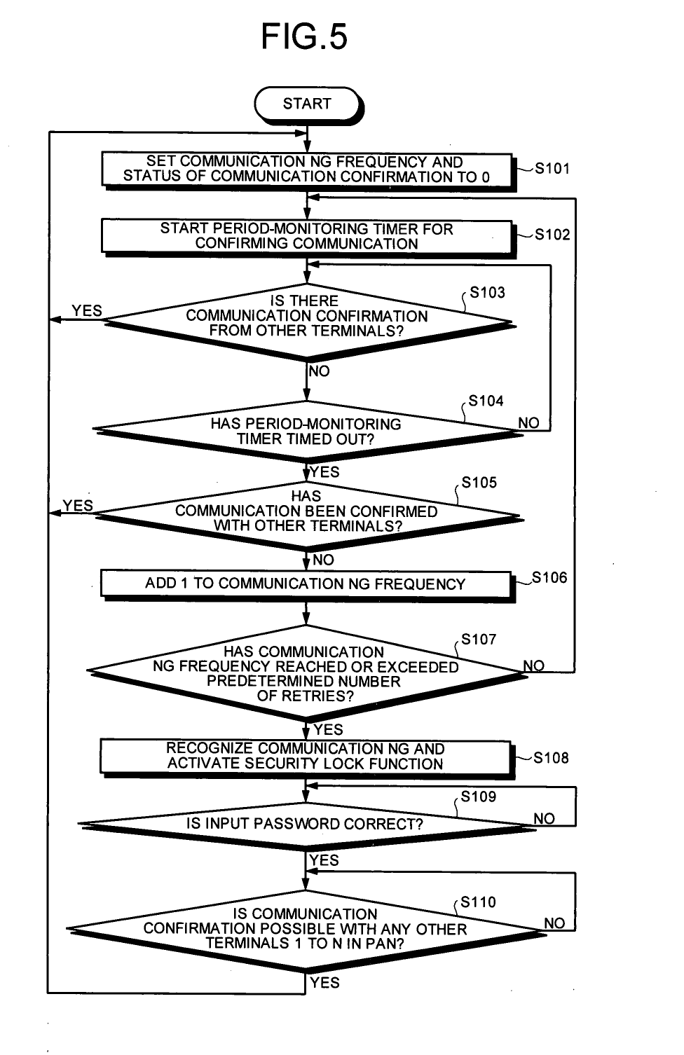

FIG. 5 is a flowchart of the communication-confirming process performed by the communication confirming unit 114 with other terminals.

As shown in FIG. 5, upon activation, the communication confirming unit 114 sets the communication NG frequency and the status of communication confirmation in the security-information storing unit 112 to “0” (step S101), and starts the period-monitoring timer 115 (step S102).

The communication confirming unit 114 then determines whether there is communication confirmation from other terminals by determining whether the status of communication confirmation is set to “1” by the communication-confirmation responding unit 113 (step S103). When there is communication confirmation from other terminals, the communication confirming unit 114 returns to step S101 to reset the communication NG frequency and the status of communication confirmation to “0”, and restarts the period-monitoring timer 115.

On the other hand, when there is no communication confirmation from other terminals, the communication confirming unit 114 determines whether the period-monitoring timer 115 has timed out (step S104). When the timer does not time out, the communication confirming unit 114 returns to step S103 to repeat determination of the status of communication confirmation from other terminals and time-out of the period-monitoring timer 115.

When the period-monitoring timer 115 times out, the communication confirming unit 114 sequentially performs communication confirmation relative to other terminals via the PAN by using other terminal identifiers 1 to n stored in the security-information storing unit 112 (step S105). When there is a response from any other terminal, because the terminal does not come off from the PAN, the communication confirming unit 114 returns to step S101 to reset the communication NG frequency and the status of communication confirmation to “0”, and restarts the period-monitoring timer 115.

When there is no response from any other terminal, the communication confirming unit 114 adds “1” to the communication NG frequency (step S106), and determines whether the communication NG frequency has reached or exceeded the predetermined number of retries (step S107).

As a result, when the communication NG frequency does not reach or exceed the predetermined number of retries, the communication confirming unit 114 returns to step S102 to restart the period-monitoring timer 115. On the other hand, when the communication NG frequency has reached or exceeded the predetermined number of retries, because the terminal comes off from the PAN and communication is not possible, the communication confirming unit 114 assumes that the terminal 100 is being illegally used, and activates the security lock function stored in the security-information storing unit 112 (step S108). It is assumed here that functions are suspended, except for the security-lock releasing function by password input as the security lock function.

The communication confirming unit 114 then waits for input of password by the user. Upon input of the password, the communication confirming unit 114 determines whether the input password is correct by comparing the password with the authentication information stored in the security-information storing unit 112 (step S109).

As a result, when the input password is not correct, the communication confirming unit 114 returns to step S109 to wait for input of the password by the user, and when the input password is correct, determines whether the communication confirmation is possible with any other terminals 1 to n in the PAN (step S110).

When communication confirmation with any other terminals 1 to n in the PAN becomes possible, the communication confirming unit 114 determines that the terminal 100 is in the PAN, enables the use of the terminal 100, and returns to step S101 to repeat the communication confirming process.

In this manner, the communication confirming unit 114 regularly confirms whether the terminal can communicate with other terminals via the PAN, and activates the security lock function when it is assumed that the terminal 100 comes off from the PAN due to a theft or the like. Accordingly, illegal use of the terminal can be prevented.

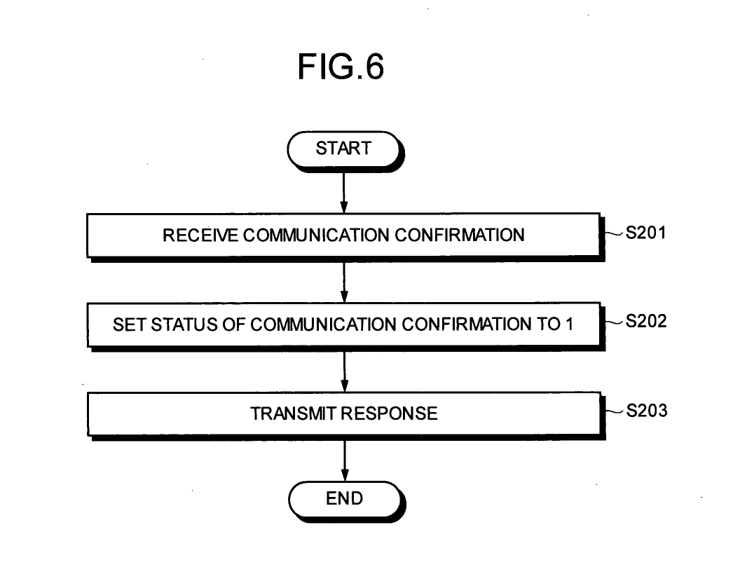

FIG. 6 is a flowchart of the response process performed by the communication-confirmation responding unit 113.

As shown in FIG. 6, when the communication-confirmation responding unit 113 receives communication confirmation from other terminals via the PAN (step S201), the communication-confirmation responding unit 113 sets the status of communication confirmation in the security-information storing unit 112 to “1” (step S202), and transmits a response to the terminal having transmitted the communication confirmation (step S203).

In this manner, when the communication-confirmation responding unit 113 receives the communication confirmation from the other terminals, the communication confirming unit 114 can recognize that the other terminals has confirmed the communication by setting the status of the communication confirmation in the security-information storing unit 112 to “1”

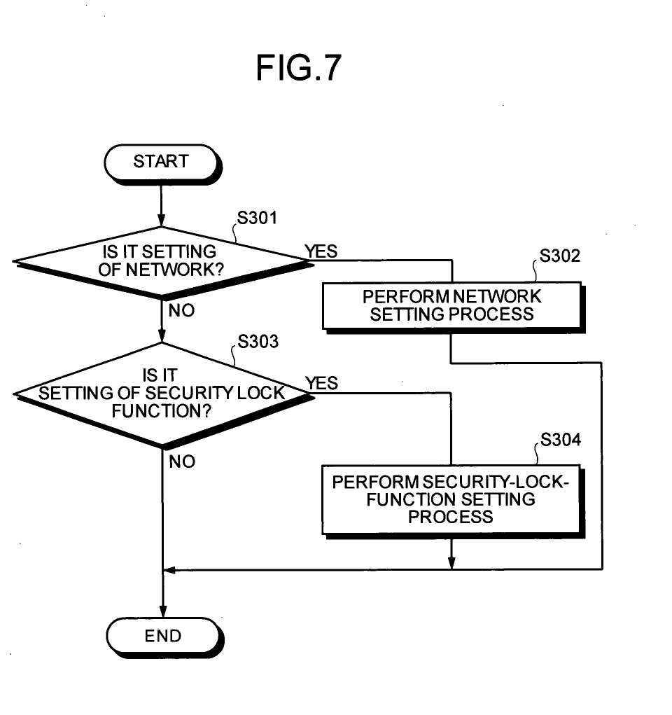

FIG. 7 is a flowchart of the setting process performed by the setting processor 111.

As shown in FIG. 7, the setting processor 111 determines whether an input by the user is a setting of a network (PAN) (step S301), and when the input is the network setting, performs a network setting process, such as storing the number of other terminals registered in the PAN and identification information for communicating with the respective terminals in the security-information storing unit 112 (step S302).

On the other hand, when the input from the user is not the network setting, the setting processor 111 determines whether the input is a setting of the security lock function (step S303). When the input is the setting of the security lock function, the setting processor 111 performs a security-lock-function setting process for storing the security lock function specified by the user in the security-information storing unit 112 (step S304).

In this manner, the setting processor 111 receives an input from the user to set the network or the security lock function, thereby operating the terminal-security protecting function.

Examples of specific combinations of terminals according to the present embodiment are explained below.

(1) Type of Mobile Phone+Wristwatch (Wearable)

A mobile phone and a wristwatch terminal form a network. In this case, only a person who wears the wristwatch terminal can use a mobile phone.

(2) Type of Mobile Phone+Wristwatch (Wearable)×n (n≧2)

A mobile phone and wristwatch terminals×n form a network, and n persons respectively wear a-wristwatch terminal. In this case, any person who wears the wristwatch terminal can use the mobile phone. Even if the mobile phone is lost, persons who do not wear the wristwatch terminal cannot use the mobile phone.

(3) Type of Personal Computer (PC)×n (n≧2)

Three or more PCs form a network, where one PC is installed in a house, and other notebook PCs are carried by two or more persons, respectively. In this case, when any person is at home (when the person has a notebook PC at home and can be connected to the network), the notebook PC can access to the PC installed in the house to read or write data. On the contrary, when nobody is at home (when the notebook PCs are not in the house), nobody can use the PC installed in the house (information of the PC installed in the house does not leak outside).

(4) Type of PC+Wristwatch (Wearable)×n (n≧2)

A PC and wristwatch terminals×n form a network, where each person wears the wristwatch terminal and the PC is installed in the house. In this case, when a person is at home (when a wristwatch terminal can be connected to the network), he or she can use the PC installed in the house. On the contrary, when there is nobody who wears the wristwatch terminal at home, nobody can use the PC installed in the house (information of the PC installed in the house does not leak outside).

(5) Type of PC+Wristwatch (Wearable)

A PC and a wristwatch terminal form a network, where a person wears the wristwatch terminal and the PC is in a car or a bag. In this case, so long as the person wears the wristwatch terminal, the PC can be used. On the other hand, even if the car or the bag is stolen, because the wristwatch terminal is at hand, information in the PC does not leak.

(6) Type of PC+Mobile Phone+Wristwatch (Wearable)

A PC, a mobile phone, and a wristwatch terminal form a network. In this case, because the wristwatch terminal and the mobile phone are normally at hand, the mobile phone can be used at all times. Further, if any one of the wristwatch terminal and the mobile phone is at hand, the person can use the PC. Therefore, even if either the wristwatch terminal or the mobile phone is lost, the PC can be used. Even if the mobile phone is lost, if the PC is at hand, other persons cannot use the mobile phone, because the mobile phone does not have a partner to make communication confirmation (information of the mobile phone does not leak outside, and unnecessary payment can be avoided).

According to the present embodiment, the communication confirming unit 114 performs communication confirmation with other terminals at a constant period via the PAN, to determine whether the terminal comes off from the PAN. When determining that the terminal 100 comes off from the PAN, the communication confirming unit 114 assumes that there is a possibility that the terminal is illegally used due to a theft or the like, and activates the security lock function stored in the security-information storing unit 112. Accordingly, illegal use of the terminal can be automatically prevented.

Furthermore, according to the present embodiment, a terminal having the terminal-security protecting unit has been explained. A terminal-security protecting program having the same function can be obtained by realizing the configuration of the terminal-security protecting unit by software. Therefore, a terminal that executes the terminal-security protecting program is explained below.

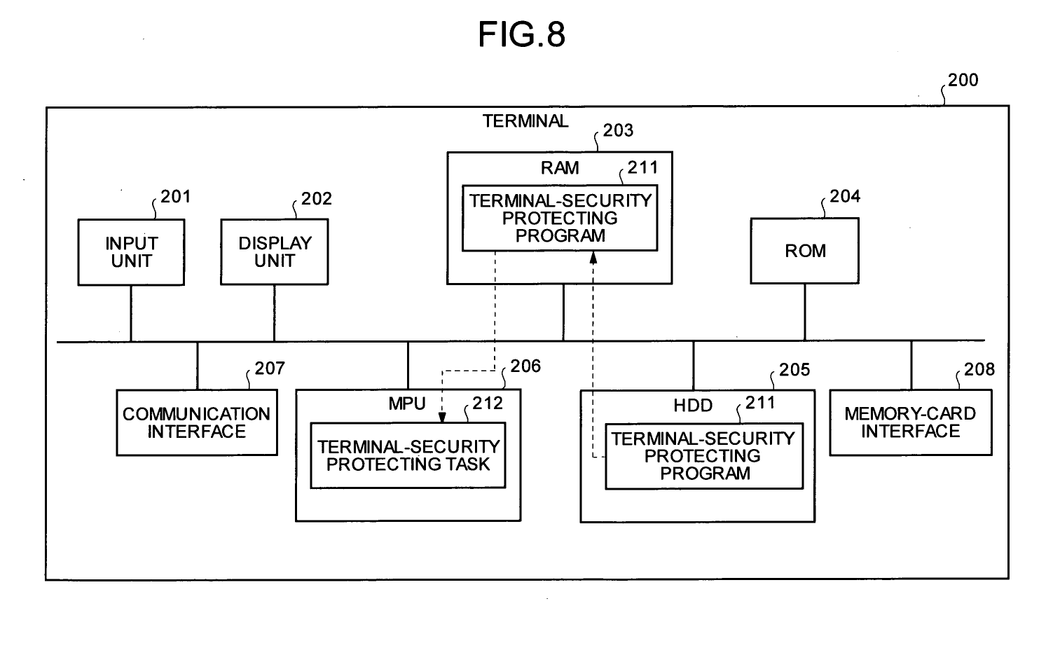

FIG. 8 is schematic diagram for explaining a hardware configuration of a terminal 200 that executes the terminal-security protecting program according to the present embodiment. The terminal 200 includes an input unit 201, a display unit 202, a random access memory (RAM) 203, a read only memory (ROM) 204, a hard disk drive (HDD) 205, a micro processing unit (MPU) 206, a communication interface 207, and a memory-card interface 208.

The input unit 201 is a keyboard used by a user to input an instruction or data to the terminal, and the display unit 202 is a liquid crystal display for displaying an output result of the terminal. The RAM 203 stores a program read from the HDD 205 or an execution interim result of the program, and the ROM 204 is a read only memory that stores a constant and the like.

The HDD 205 stores a program executed by the MPU 206 and various pieces of information, and the MPU 206 reads the program from the HDD 205 to the RAM 203 to execute the program.

The communication interface 207 is for connecting the terminal to the PAN, and the memory-card interface 208 is for read and write of the memory card.

A terminal-security protecting program 211 installed in the HDD 205 is read by the MPU 206 onto the. RAM 203 and executed as a terminal-security protecting task 212 by the MPU 206.

The terminal-security protecting program 211 is read from the memory card and installed in the HDD 205. Alternatively, the terminal 200 can receive the terminal-security protecting program 211 from another terminal via the PAN and install the program in the HDD 205.

According to the present embodiment, a case that the terminal communicates with other terminals via the PAN has been explained. However, the present invention is not limited thereto, and for example, the present invention is applicable to a case that communication is performed, for example, between a wristwatch terminal and a ring type terminal by causing a minute current to flow to a human body.

As described above, according to one aspect of the present invention, when the terminal is illegally used, the use of the terminal is restricted automatically. Accordingly, the security of the terminal can be reliably protected.

Furthermore, according to another aspect of the present invention, because it is reliably determined whether the terminal is in a communicable state with another terminal, the security of the terminal can be reliably protected.

Moreover, according to still another aspect of the present invention, because useless communication confirmation is prevented, the security of the terminal can be effectively protected.

Furthermore, according to still another aspect of the present invention, because occurrence of use restriction of the terminal due to temporary communication interruption is prevented, useless use restriction can be eliminated.

Moreover, according to still another aspect of the present invention, because illegal use of the terminal and information leakage from the terminal can be prevented, the security of the terminal can be protected.

Furthermore, according to still another aspect of the present invention, because use restriction according to a security level is imposed, flexible security protection can be realized.

Moreover, according to still another aspect of the present invention, illegal use of a mobile phone and information leakage from the mobile phone are prevented by using a wristwatch type terminal. Accordingly, the security of the mobile phone can be reliably protected.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for protecting an illegal use of a terminal, the apparatus comprising:
a determining unit that determines whether the terminal is in a communicable state with other terminal via a personal area network; and
a restricting unit that restricts use of the terminal, when the determining unit determines that the terminal is not in the communicable state.

2. The apparatus according to claim 1, wherein the determining unit performs a communication confirmation with the other terminal via the personal area network at a predetermined time interval, and when a communication is confirmed with the other terminal, determines that the terminal is in the communicable state.

3. The apparatus according to claim 2, wherein the determining unit performs the communication confirmation with the other terminal, when there is no communication confirmation by the other terminal within the predetermined time interval.

4. The apparatus according to claim 2, wherein the determining unit performs the communication confirmation with the other terminal for a predetermined number of times at the predetermined time interval, and when there is no response from the other terminal to the communication confirmation for the predetermined number of times, determines that the terminal is not in the communicable state.

5. The apparatus according to claim 1, wherein the restricting unit restricts the use of the terminal by suspending functions other than a function of releasing a security lock.

6. The apparatus according to claim 1, wherein the restricting unit restricts the use of the terminal by cutting off a power of the terminal after making a setting that requires an authentication with turning on the power.

7. The apparatus according to claim 1, further comprising a registering unit that registers a function of restricting the use of the terminal when the determining unit determines that the terminal is not in the communicable state, wherein
the restricting unit restricts the use of the terminal to the function registered by the registering unit.

8. The apparatus according to claim 1, wherein
the terminal is a mobile phone, and
the other terminal is a wristwatch terminal.

9. A method of protecting an illegal use of a terminal, the method comprising:
determining whether the terminal is in a communicable state with other terminal via a personal area network; and
restricting use of the terminal, when it is determined that the terminal is not in the communicable state.

10. A computer-readable recording medium that stores therein a computer program for protecting an illegal use of a terminal, the computer program causing a computer to execute:
determining whether the terminal is in a communicable state with other terminal via a personal area network; and
restricting use of the terminal, when it is determined that the terminal is not in the communicable state.
